(19) United States
(12) Patent Application Publication
(10) Pub. No.: US 2026/0371159 A1
(43) Pub. Date: Nov. 19, 2026

(54) DELAY STATUS REPORT TRIGGERING

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 19/674,877

(22) Filed: May 12, 2026

Related U.S. Application Data
(60) Provisional application No. 63/808,383, filed on May 19, 2025.

(51) Int. Cl. H04W 28/02; H04W 28/06

(52) U.S. Cl. CPC H04W 28/0278; H04W 28/06

(57) ABSTRACT

Various aspects of the present disclosure generally relate to wireless communication. In some aspects, a user equipment (UE) may identify a discard timer threshold for delay status report triggering. The UE may trigger a delay status report for a radio link control (RLC) retransmission of a protocol data unit (PDU) based at least in part on a discard time associated with the PDU being below the discard timer threshold. Numerous other aspects are described.

### CROSS-REFERENCE TO RELATED APPLICATION

This Patent Application claims priority to U.S. Provisional Patent Application No. 63/808,383, filed on May 19, 2025, entitled “DELAY STATUS REPORT TRIGGERING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with delay status report triggering.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Delay status reports (DSRs) in a wireless communication system provide vital information on uplink data buffered in a user equipment (UE), aiding efficient resource scheduling and enhancing quality of service (QoS). DSR mechanisms are suitable for applications demanding reduced latency, improved throughput, and minimized errors. When a discard time falls below a threshold, the DSR mechanism alerts the network node of the data’s delay-critical nature, ensuring timely transmission. DSRs can work alongside buffer status reports (BSRs), which inform the network about the total data buffered in the UE without considering the discard timer status.

### SUMMARY

Some aspects described herein relate to a method of wireless communication performed by a user equipment (UE). The method may include identifying a discard timer threshold for delay status report triggering. The method may include triggering a delay status report for a radio link control (RLC) retransmission of a protocol data unit (PDU) based at least in part on a discard time associated with the PDU being below the discard timer threshold.

Some aspects described herein relate to a UE for wireless communication. The UE may include a processing system. The processing system may include one or more processors and one or more code-storing memories coupled with the one or more processors. The processing system may be configured to cause the UE to identify a discard timer threshold for delay status report triggering. The processing system may be configured to cause the UE to trigger a delay status report for an RLC retransmission of a PDU based at least in part on a discard time associated with the PDU being below the discard timer threshold.

Some aspects described herein relate to a non-transitory computer-readable medium that stores a set of instructions for wireless communication by a UE. The set of instructions, when executed by one or more processors of the UE, may cause the UE to identify a discard timer threshold for delay status report triggering. The set of instructions, when executed by one or more processors of the UE, may cause the UE to trigger a delay status report for an RLC retransmission of a PDU based at least in part on a discard time associated with the PDU being below the discard timer threshold.

Some aspects described herein relate to an apparatus for wireless communication. The apparatus may include means for identifying a discard timer threshold for delay status report triggering. The apparatus may include means for triggering a delay status report for an RLC retransmission of a PDU based at least in part on a discard time associated with the PDU being below the discard timer threshold.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a user plane protocol stack and a control plane protocol stack for a network node and a core network in communication with a UE.

FIG. 3 is a diagram of an example associated with delay status report triggering.

FIG. 4 is a diagram illustrating an example process performed, for example, at a UE or an apparatus of a UE.

FIG. 5 is a diagram of an example apparatus for wireless communication.

### DETAILED DESCRIPTION

Delay status reports (DSRs) are used in wireless communication systems to provide time-sensitive information regarding uplink data buffered in a user equipment (UE) to the network, enabling more efficient resource scheduling and improved quality of service (QoS). Therefore, DSR mechanisms may be used for applications requiring enhanced QoS characteristics such as reduced latency, improved throughput, and minimized errors. DSRs may be triggered based at least in part on a remaining discard time of uplink data packets buffered in specific logical channel groups (LCGs) within the UE. The remaining discard time may be controlled by a packet data convergence protocol (PDCP) discard timer, which determines the maximum time that a packet is considered valid for transmission. If the remaining discard time of a packet falls below a threshold, the DSR mechanism may allow the UE to notify the serving network node of the delay-critical nature of the data, facilitating timely scheduling and transmission. In some cases, the DSR mechanism may operate in parallel with buffer status reports (BSRs), which provide the network with information regarding the total volume of data buffered in the UE, regardless of the discard timer status. While BSRs are effective for general scheduling purposes, they may lack sufficient granularity to distinguish between packets that are delay-critical and packets with sufficient time remaining for transmission.

DSR mechanisms may be limited in scope. For example, DSR procedures may be defined solely for PDCP service data units (SDUs) that have not yet been transmitted and whose remaining discard time has fallen below the configured threshold for the first time. Once a DSR is triggered and the associated data is transmitted, subsequent events such as retransmissions of the same data may not be considered by the DSR mechanism. This limitation may create inefficiencies in scenarios involving retransmissions. Retransmissions may occur due to various factors, such as an RLC poll timer expiry, autonomous retransmissions by the UE, or negative acknowledgement (NACK) message transmissions transmitted by the network node to the UE. In these cases, the remaining discard time of the retransmitted data may fall below the configured DSR threshold, but the current DSR mechanism may not account for retransmissions. As a result, the network scheduler may be unaware of the critical timing requirements associated with the retransmitted data, leading to suboptimal resource allocation and increased risk of packet discard. Additionally, while BSRs are governed by periodic and prohibit timers to control reporting frequency, DSRs lack similar mechanisms, making it difficult to address retransmission scenarios dynamically. This gap in the DSR framework may limit an ability of a scheduling device to refine grant patterns and optimize transmission opportunities for both new and retransmitted data.

Various aspects relate generally to DSR triggering. Some aspects more specifically relate to enhancing DSR mechanisms in wireless communication systems to account for retransmission scenarios and improve quality of service. In some aspects, DSR triggering processes may dynamically account for retransmitted PDUs based at least in part on various protocol variables, such as poll timer expiry, autonomous retransmissions, and NACK messages received from the network. Additionally or alternatively, the DSR triggering processes may be based at least in part on retransmissions triggered by application-specific requirements, inputs from internal entities within the modem or application processor, and thresholds derived within the modem based at least in part on protocol states, application traffic, or external inputs. Further, the DSR triggering processes may be based at least in part on discard timer thresholds or transmission grants from the network to facilitate the DSR process. Once triggered, the DSR may be composed and sent as part of a DSR medium access control (MAC) control element within a MAC transport block.

In some aspects, the DSR triggering processes may improve scheduler coordination by providing time-sensitive information about retransmitted PDUs, allowing the network to refine resource allocation and grant patterns based at least in part on updated delay-critical data. By including retransmitted PDUs in the DSR mechanism, the disclosed techniques may enable the network to identify and prioritize packets that are critical for meeting QoS requirements, such as minimizing latency and packet discard rates. Therefore, the wireless communication system may conserve network resources by ensuring efficient scheduling decisions, reducing unnecessary retransmissions, and avoiding packet loss that would otherwise require additional retransmission attempts.

Particular aspects of the subject matter described in this disclosure can be implemented to realize one or more of the following advantages. By including retransmitted PDUs in DSR calculations, the disclosed techniques address inefficiencies in the existing DSR framework, which may only consider new PDCP SDUs for DSR triggering. This process may improve a likelihood that retransmitted data with critical timing requirements is reported to the network, enabling more efficient and timely scheduling decisions. For example, retransmitted PDUs associated with poll timer expiry, autonomous retransmissions, or explicit NACKs from the network can serve as additional triggers for DSR, ensuring that packets nearing expiration are given priority for transmission. Therefore, the described techniques may reduce the need for redundant retransmission cycles and optimize the use of available uplink resources.

Additionally, by dynamically accounting for retransmitted PDUs based at least in part on discard timer thresholds, the DSR triggering processes described herein may provide finer granularity in resource allocation decisions, enabling more effective handling of delay-critical data alongside other uplink traffic. This approach may reduce packet discard rates and conserve network bandwidth that would otherwise be consumed by repeated retransmissions of expired packets. Furthermore, the inclusion of retransmitted PDUs in DSR triggering may improve system efficiency and reliability by ensuring that all packets are considered for timely transmission within their QoS constraints, thereby optimizing resource utilization for latency-sensitive applications such as extended reality (XR), industrial automation, and Internet of Things (IoT) scenarios.

5G New Radio (NR) may support enhanced mobile broadband (eMBB) access, IoT networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

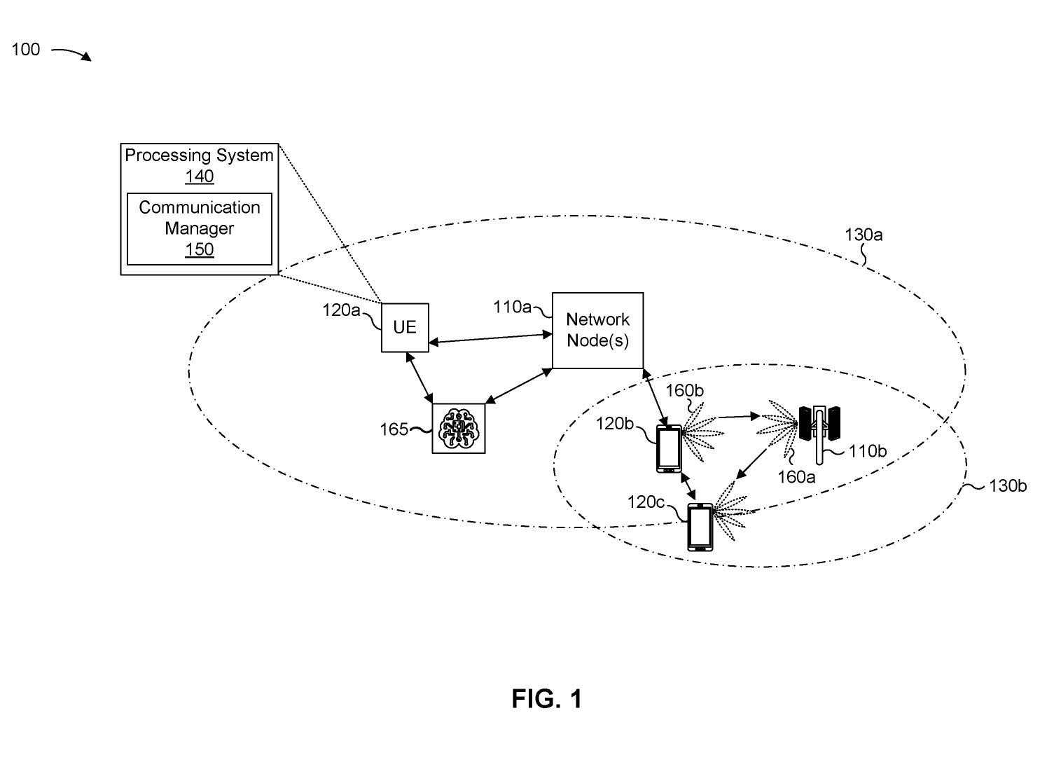

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140. A processing system (for example, the processing system 140) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 may each include or be coupled with one or more modems (such as a cellular (for example, a 5G or 6G compliant) modem). In some examples, one or more processors of the processing system 140 may include or implement one or more of the modems. The processing system 140 also may include or be coupled with multiple radios (collectively “the radio”), multiple RF chains, or multiple transceivers, each of which may in turn be coupled with one or more of multiple antennas. In some examples, one or more processors of the processing system 140 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 140) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 140, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 140, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based at least in part on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 140, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 140, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based at least in part on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110, one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may identify a discard timer threshold for delay status report triggering; and trigger a delay status report for an RLC retransmission of a PDU based at least in part on a discard time associated with the PDU being below the discard timer threshold. Additionally, or alternatively, the communication manager 150 may perform one or more other operations described herein.

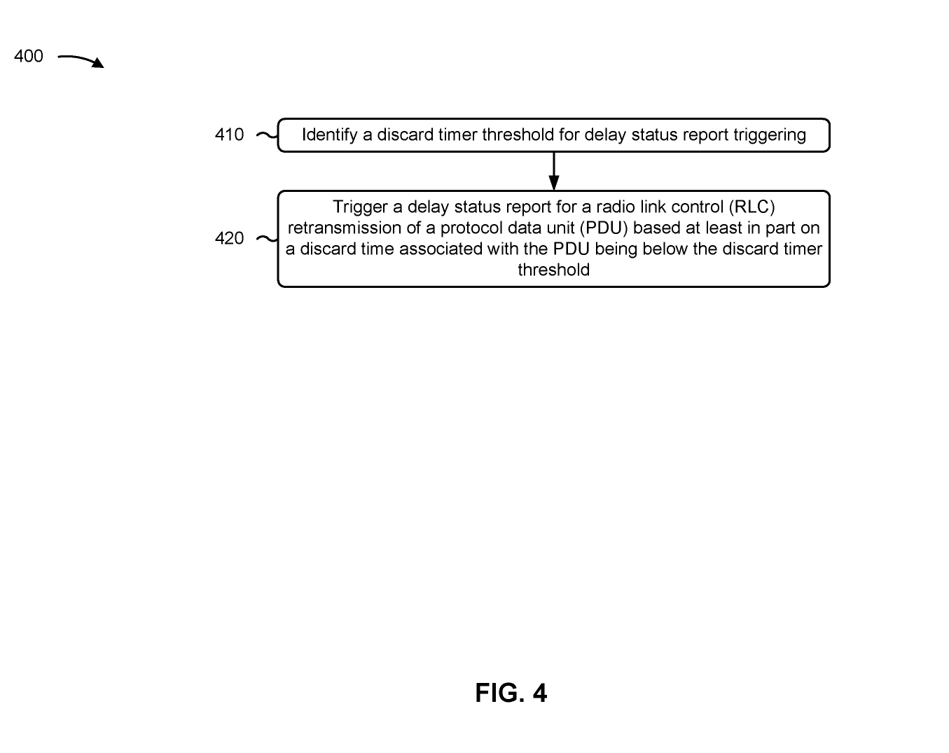

The network node 110, the UE 120, the processing system 140 of the UE 120, or any other component(s) of FIG. 1 may implement one or more techniques or perform one or more operations associated with delay status report triggering, as described in more detail elsewhere herein. For example, the network node 110, or the processing system 140 of the UE 120 may perform or direct operations of, for example, process 400 of FIG. 4, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 140) of the network node 110, or the UE 120, may cause the one or more processors to perform process 400 of FIG. 4, or other processes as described herein. In some examples, executing instructions may include running the instructions, converting the instructions, compiling the instructions, or interpreting the instructions, among other examples.

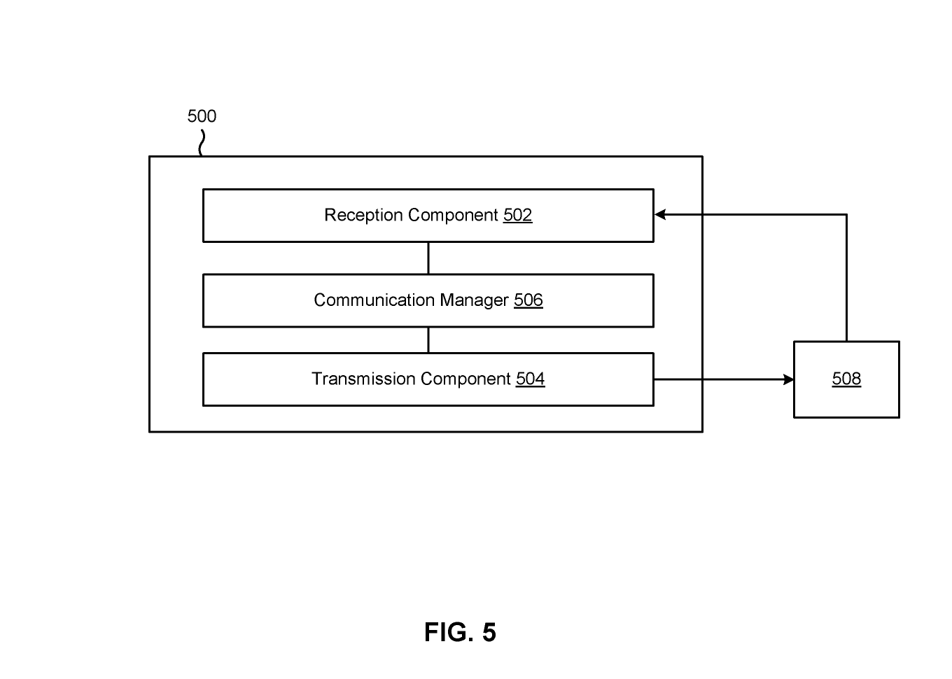

In some aspects, the UE 120 includes means for identifying a discard timer threshold for delay status report triggering; or means for triggering a delay status report for an RLC retransmission of a PDU based at least in part on a discard time associated with the PDU being below the discard timer threshold. The means for the UE 120 to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

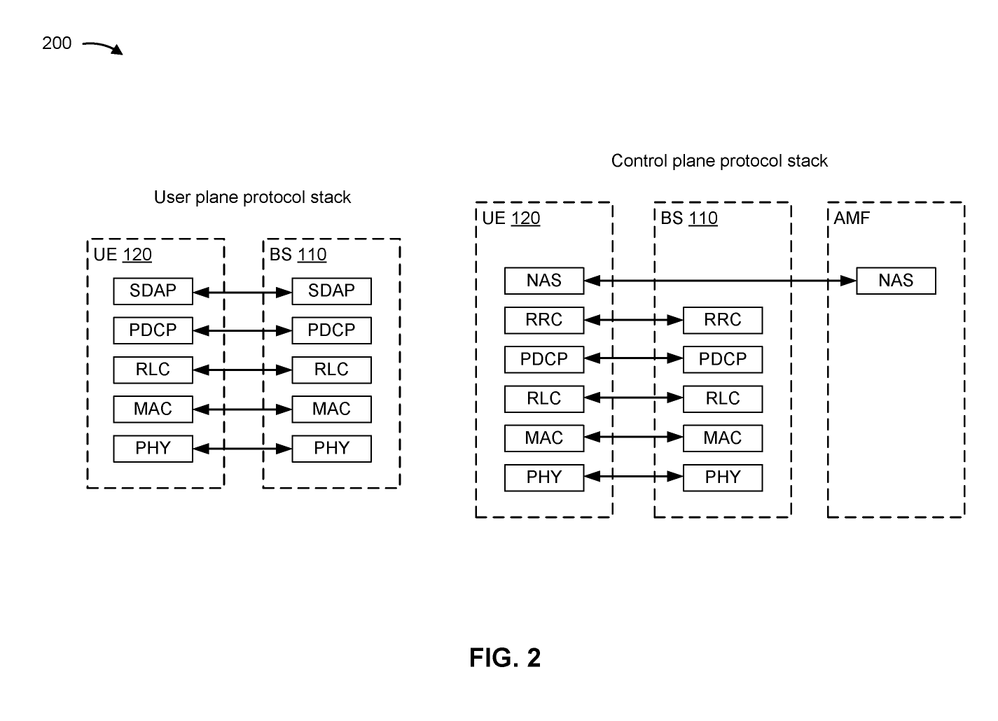

FIG. 2 is a diagram illustrating an example 200 of a user plane protocol stack and a control plane protocol stack for a network node 110 and a core network in communication with a UE 120. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the network node 110. On the control plane, the UE 120 and the network node 110 may include respective radio resource control (RRC) layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 2, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer vian RLC channels. The RLC layer may handle transfer of upper layer PDUs to the MAC or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

In some examples, a DSR may be configured with multiple inputs from the network node 110, for example, to indicate the data that is running in order for traffic QoS requirements (e.g., throughput, error, and latency) to be well supported. The network node 110 can configure a DSR remaining time threshold (remainingTimeThreshold)as a baseline threshold. The DSR may assist the scheduler in timely assigning resources to meet QoS requirements with fine granularity when combined with various other traffic sources associated with the UE 120.

In some examples, the DSR may be used to provide a serving network node 110 with a delay status of a logical channel group (LCG). The RRC layer may control the DSR process by configuring one or more parameters per LCG. One parameter may be the remaining time threshold (remainingTimeThreshold) parameter, which indicates a remaining time for triggering a DSR for a logical channel within an LCG. Additionally or alternatively, the remaining time threshold parameter may be used for reporting an amount of UL data buffered in an LCG in a single entry DSR MAC-CE. Another parameter may be a DSR reporting threshold list (dsr-ReportingThresList), which indicates a list of thresholds on remaining times for reporting the amount of UL data buffered in the LCG in the multiple entry DSR MAC-CE.

In some examples, MAC control elements may be used to transmit various configuration information, radio environment measurements, and other information from the UE 120 to the network node 110 (in uplink). A MAC-CE can carry upper layer protocol related information, such as lower-layer triggered mobility (LTM) and BSR, as well as PHY layer information such as power headroom (PHR) and beam related information. MAC control elements are important from a time and reliability perspective as they can influence the network all the way from simple scheduling enhancements to configuration changes.

DSR and BSR procedures may be centered around total data to be transmitted in the UE 120 from the upper layers as well as the remaining time associated with the upper layer packets in the context of PDCP discard timer configuration. Current DSR processes may be defined only around the PDCP SDUs buffered for transmission running discard timer falling below a configured threshold. The discard timer is valid not from the first transmission, but rather until the successful delivery. A PDU set QoS parameter success may depend on the successful transmission rather than initial transmission alone. If an LCG is configured for delay status reporting, the MAC entity may, for each logical channel within the LCG, if the smallest remaining value of the running PDCP discardTimers among all the PDCP SDUs buffered for the logical channel that have not been transmitted in any MAC PDU and have not been reported as data volume in a DSR MAC-CE becomes below remainingTimeThreshold of the LCG, and if there is no DSR pending for the logical channel, trigger a DSR for the logical channel.

In some cases, a significant amount of traffic may be queued into a PDCP SDU queue, and an associated discard timer may be started for each PDU. When the remaining time of the discard timer falls below the remainingTimeThreshold value, the DSR is triggered and a DSR MAC-CE is transmitted. From the network perspective, the network node 110 may have (optionally) provided a grant for the UE 120 to transmit the DSR triggered PDCP SDUs in an UL MAC TB. In an example where the network nodes 110 provides the grant for the UE 120 to transmit the DSR triggered PDCP SDUs in the UL MAC TB, even when all packets have been transmitted, an RLC poll timer may have expired, and some of the PDUs that belong to the DSR triggered MAC-CE may be ready to transmit (even though they are not new PDUs that fell below the remainingTimeThreshold for the first time). Additionally or alternatively, the UE 120 may perform autonomous retransmissions to improve a reliability of traffic within an expected delay budget. Additionally or alternatively, the network node 110 may send an RLC NACK which (explicitly) indicates that the UE 120 is to send the packets as part of the retransmission (even though they are not new PDUs that fell below the remainingTimeThreshold for the first time). In some cases, the UE 120 may only trigger a DSR MAC-CE when a new packet comes below the remainingTimeThreshold for the first time, which may result in reduced throughput, increased latency, and an increased quantity of transmission errors, among other examples,

As indicated above, FIG. 2 is provided as an example. Other examples may differ from what is described with regard to FIG. 2.

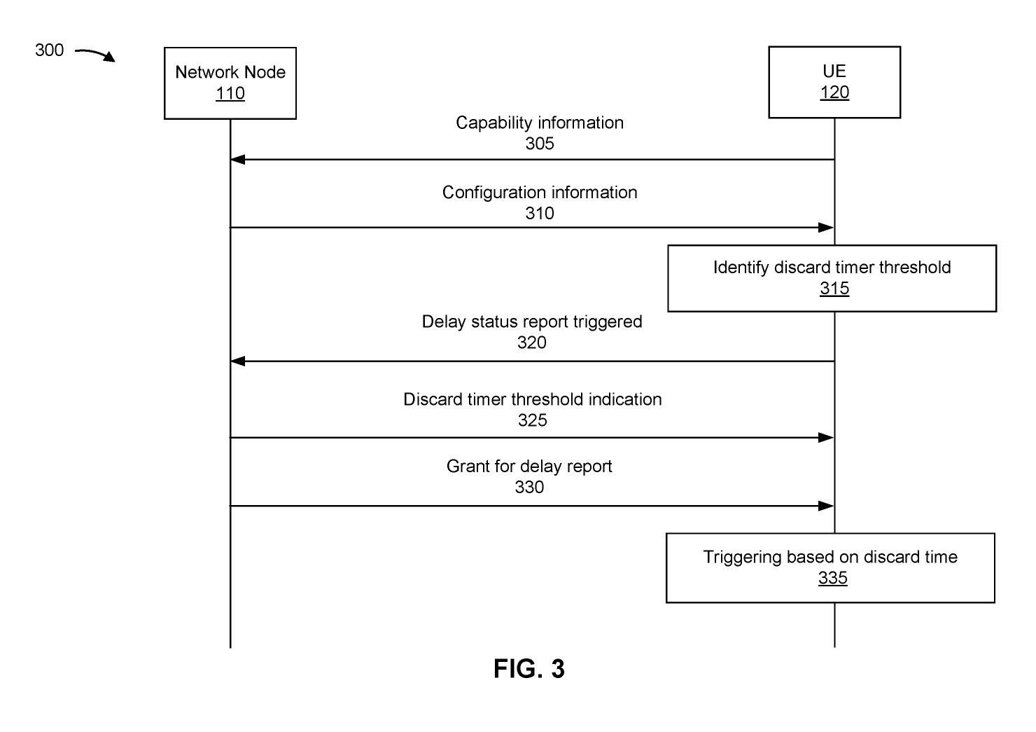

FIG. 3 is a diagram of an example 300 associated with delay status report triggering. As shown in FIG. 3, a network node 110 (e.g., a base station, a CU, a DU, or an RU) may communicate with a UE 120. In some aspects, the network node 110 and the UE 120 may be part of a wireless network (e.g., the wireless communication network 100). In some aspects, the UE 120 and the network node 110 may have established a wireless connection prior to operations shown in FIG. 3.

In some aspects, as shown by reference number 305, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report. In some aspects, the capability information may indicate whether the UE 120 supports a feature or one or more parameters related to the feature. For example, the capability information may indicate a capability or parameter for transmitting radio capabilities to the network node 110 during the initial attach process. As another example, the capability information may indicate a capability or parameter for identifying a discard timer threshold for delay status report triggering. One or more operations described herein may be based at least in part on capability information. For example, the UE 120 may perform a communication in accordance with the capability information, or may receive configuration information that is in accordance with the capability information. In some aspects, the capability information may indicate UE support for triggering a delay status report for a retransmission of a PDU based at least in part on conditions such as a discard time being below the discard timer threshold, protocol variables, application-specific requirements, or interconnect types between a modem and an application processor.

As shown by reference number 310, the network node 110 may transmit, and the UE 120 may receive, configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as 3GPP standards. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, as shown by reference number 305, the UE 120 may transmit capability information. For example, UE 120 may transmit radio capabilities to the network node 110 during the initial attach procedure. In this way, transmitting capability information may ensure that the network node is aware of the UE’s capabilities for optimal configuration.

In some aspects, as shown by reference number 310, the network node 110 may provide configuration information to the UE 120. For example, the network node may send configuration parameters such as scheduler settings and threshold values to the UE 120. In this way, providing configuration information may enable the UE 120 to optimize its uplink transmissions according to network conditions.

In some aspects, as shown by reference number 315, UE 120 may identify a discard timer threshold for delay status report triggering. For example, the UE 120 may determine that the remaining time on a PDCP discard timer is below the configured threshold for a logical channel. In this way, identifying a discard timer threshold may allow the UE to trigger delay status reports when data is at risk of not meeting QoS requirements.

In some aspects, identifying the discard timer threshold may be based at least in part on a threshold derived within a modem of the UE 120, based at least in part on a protocol state, application traffic, or an external input received from an application processor. For example, the modem may dynamically adjust the threshold according to real-time traffic conditions and protocol state changes. Deriving the threshold based at least in part on such inputs may enhance flexibility and responsiveness in maintaining QOS.

In some aspects, as shown by reference number 320, the UE 120 may trigger a delay status report for an RLC retransmission of a PDU based at least in part on a discard time associated with the PDU being below the discard timer threshold. For example, the UE 120 may initiate a delay status report when a retransmitted PDU’s discard timer falls below the set threshold, regardless of whether it was initially transmitted with a DSR MAC-CE. In this way, triggering a delay status report for an RLC retransmission may ensure timely retransmission and enhance QOS by informing the scheduler of critical retransmissions.

In some aspects, RLC retransmission PDUs not previously associated with a DSR MAC-CE may trigger delay status reporting. For example, original RLC transmissions without DSR MAC-CE association may be queued for retransmission due to protocol triggers like poll timer expiry or network-based RLC NACKs, and subsequently fall below the remaining time threshold. Including such PDUs may ensure that delay status reports are triggered even for retransmissions initially outside DSR MAC-CE processes.

In some aspects, triggering the delay status report for the RLC retransmission of the PDU may be based at least in part on an indication of one or more protocol variables. For example, protocol variables such as queue length or poll timer expiry may signal the need for retransmission. In some aspects, the indication of the one or more protocol variables may include an indication associated with at least one of a poll timer, a time duration, a retransmission count, a bearer type, or a PDU session type. The bearer type may be, for example, an application signaling bearer type, a user traffic bearer type, an application signaling bearer type, or a dedicated bearer type. The PDU session type may be, for example, a default PDU session type, a dedicated PDU session type, or a management PDU session type. Using protocol variables as triggers may refine the timing and necessity of delay status reports. Additionally or alternatively, the indication of the one or more protocol variables may comprise an indication associated with a poll timer. For example, expiry of the poll timer may necessitate the immediate retransmission of PDUs. Associating delay status report triggers with poll timer indications may enhance synchronization with protocol operations. Additionally or alternatively, triggering the delay status report for the RLC retransmission may be based at least in part on an indication of one or more protocols. For example, protocol-specific thresholds or events may dictate when a retransmission is essential. Using protocol indications may ensure that retransmissions are aligned with protocol-specific requirements. Additionally or alternatively, the indication of the one or more protocols may comprise an indication associated with an autonomous retransmission of the PDU. For example, autonomous retransmission logic may initiate a delay status report when conditions are met. Associating delay status report triggers with autonomous retransmissions may improve reliability by adapting to UE-specific parameters.

In some aspects, triggering the delay status report for the RLC retransmission of the PDU may be based at least in part on the UE 120 receiving a negative acknowledgment message from a peer RLC device via a status PDU indicator or based at least in part on an implicit negative acknowledgement that is derived based at least in part on a HARQ feedback indication or a medium access control signal. For example, upon receiving a negative acknowledgment, the UE 120 may prioritize retransmission and delay status report generation. Using negative acknowledgment messages may ensure prompt action in response to failed transmissions.

In some aspects, triggering the delay status report for the RLC retransmission of the PDU may be based at least in part on one or more application-specific requirements, such as an application-specific protocol, an application-specific packet type, or an application-specific importance bit. For example, real-time applications may have strict latency requirements necessitating timely retransmissions. In some aspects, the one or more application specific requirements (e.g., agentic AI traffic, XR traffic, or background traffic) may include an application-specific protocol, an application-specific traffic type (e.g., an I-frame, a P-frame, or a B-frame), or an application-specific importance indicator. The application-specific importance indicator may include a transmission control protocol (TCP) indication (e.g., a TCP indication comprising an urgency indication or a type of service indication), a differentiated services code point (DSCP) indication, an Ethernet priority code point (PCP) indication, or a virtual local area network (LAN) indication). Using application-specific requirements may optimize retransmission timing for diverse application needs.

In some aspects, triggering the delay status report for the RLC retransmission of the PDU may be based at least in part on one or more inputs from one or more entities within a modem or an application processor of the UE 120. For example, inputs such as buffer status or processing load may inform retransmission decision-making. Using inputs from multiple entities may provide a holistic view for retransmission needs.

In some aspects, triggering the delay status report for the RLC retransmission of the PDU may be based at least in part on a type of interconnect between a modem and an application processor of the UE 120. For example, specific interconnect types may influence data flow and retransmission urgency. Considering interconnect types may tailor retransmission strategies to hardware configurations.

In some aspects, triggering the delay status report for the RLC retransmission of the PDU may be based at least in part on a negative acknowledgment message received from a network node. For example, network-triggered negative acknowledgment may prompt immediate retransmission and delay status reporting. Using network-derived acknowledgments may synchronize UE actions with network expectations.

In some aspects, triggering the delay status report may comprise generating the delay status report and sending the delay status report as part of a delay status report MAC-CE within a MAC transport block. For example, the UE 120 may encapsulate delay status information within MAC control elements for transmission. Using MAC control elements for delay status reports may streamline the communication of critical delay information.

In some aspects, a multiple threshold configuration using dsr-ReportingThresList may be utilized. For example, the network may configure a list of thresholds on remaining time for reporting buffered uplink data in logical channel groups using a multiple-entry DSR MAC control element. Leveraging multiple thresholds may provide finer granularity in delay status reporting.

In some aspects, as shown by reference number 325, the network node 110 may provide the UE 120 with an indication of the discard timer threshold. For example, the network node may update the UE 120 with new discard timer threshold values periodically or based at least in part on network conditions. In this way, providing the UE with an indication of the discard timer threshold may help in dynamically adjusting the UE’s behavior to maintain QOS.

In some aspects, as shown by reference number 330, the network node 110 may provide the UE 120 with a grant for transmitting the delay status report. For example, the network node may allocate uplink resources specifically for the UE 120 to send delay status reports when thresholds are met. In this way, providing a grant for transmitting the delay status report may ensure that crucial delay information is communicated promptly to assist in effective scheduling.

In some aspects, as shown by reference number 335, the UE 120 may trigger the delay status report based at least in part on the discard time being below the discard timer threshold. For example, the UE 120 may automatically send a delay status report when the remaining time for any buffered PDCP SDU falls below the configured threshold. In this way, triggering the delay status report based at least in part on the discard time may help the network node in prioritizing resources to maintain QOS by avoiding unnecessary delays.

In some aspects, triggering logic based at least in part on “first time” occurrence of PDCP SDUs and retransmission conditions may be employed. For example, delay status reporting may be triggered only when new PDUs fall below the remaining time threshold for the first time, avoiding repeated triggers for the same data. Implementing a “first time” condition may differentiate new events from ongoing retransmission scenarios.

As indicated above, FIG. 3 is provided as an example. Other examples may differ from what is described with regard to FIG. 3.

FIG. 4 is a diagram illustrating an example process 400 performed, for example, at a UE or an apparatus of a UE. Example process 400 is an example where the apparatus or the UE (e.g., UE 120) performs operations associated with delay status report triggering.

As shown in FIG. 4, in some aspects, process 400 may include identifying a discard timer threshold for delay status report triggering (block 410). For example, the UE (e.g., using communication manager 506, depicted in FIG. 5) may identify a discard timer threshold for delay status report triggering, as described above.

As further shown in FIG. 4, in some aspects, process 400 may include triggering a delay status report for an RLC retransmission of a PDU based at least in part on a discard time associated with the PDU being below the discard timer threshold (block 420). For example, the UE (e.g., using communication manager 506, depicted in FIG. 5) may trigger a delay status report for an RLC retransmission of a PDU based at least in part on a discard time associated with the PDU being below the discard timer threshold, as described above.

Process 400 may include additional aspects, such as any single aspect or any combination of aspects described below or in connection with one or more other processes described elsewhere herein.

In a first aspect, the delay status report for the RLC retransmission of the PDU is triggered based at least in part on an indication of one or more protocol variables.

In a second aspect, alone or in combination with the first aspect, the indication of the one or more protocol variables comprises an indication associated with a poll timer.

In a third aspect, alone or in combination with one or more of the first and second aspects, the delay status report for the RLC retransmission of the PDU is triggered based at least in part on an indication of one or more protocols.

In a fourth aspect, alone or in combination with one or more of the first through third aspects, the indication of the one or more protocols comprises an indication associated with an autonomous retransmission of the PDU.

In a fifth aspect, alone or in combination with one or more of the first through fourth aspects, the delay status report for the RLC retransmission of the PDU is triggered based at least in part on the UE receiving a negative acknowledgment message from a peer RLC device via a status PDU indicator.

In a sixth aspect, alone or in combination with one or more of the first through fifth aspects, the delay status report for the RLC retransmission of the PDU is triggered based at least in part on one or more application-specific requirements.

In a seventh aspect, alone or in combination with one or more of the first through sixth aspects, the delay status report for the RLC retransmission of the PDU is triggered based at least in part on one or more inputs from one or more entities within a modem or an application processor of the UE.

In an eighth aspect, alone or in combination with one or more of the first through seventh aspects, the delay status report for the RLC retransmission of the PDU is triggered based at least in part on a type of interconnect between a modem and an application processor of the UE.

In a ninth aspect, alone or in combination with one or more of the first through eighth aspects, process 400 includes receiving, from a network node, an indication of the discard timer threshold.

In a tenth aspect, alone or in combination with one or more of the first through ninth aspects, the discard timer threshold is identified based at least in part on a threshold, derived within a modem of the UE, based at least in part on a protocol state, application traffic, or an external input received from an application processor.

In an eleventh aspect, alone or in combination with one or more of the first through tenth aspects, the delay status report for the RLC retransmission of the PDU is triggered based at least in part on a negative acknowledgement message received from a network node.

In a twelfth aspect, alone or in combination with one or more of the first through eleventh aspects, process 400 includes receiving, from a network node, a grant for transmitting the delay status report.

In a thirteenth aspect, alone or in combination with one or more of the first through twelfth aspects, triggering the delay status report comprises generating the delay status report and sending the delay status report as part of a delay status report MAC control element within a MAC transport block.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication. The apparatus 500 may be a UE, or a UE may include the apparatus 500. In some aspects, the apparatus 500 includes a reception component 502, a transmission component 504, or a communication manager 506, which may be in communication with one another (for example, via one or more buses or one or more other components). In some aspects, the communication manager 506 is the communication manager 150 described in connection with FIG. 1. As shown, the apparatus 500 may communicate with another apparatus 508, such as a UE or a network node (such as a CU, a DU, an RU, or a base station), using the reception component 502 and the transmission component 504. The communication manager 506 may be included in, or implemented via, a processing system (for example, the processing system 140 described in connection with FIG. 1) of the UE.

In some aspects, the apparatus 500 may be configured to perform one or more operations described herein in connection with FIG. 3. Additionally, or alternatively, the apparatus 500 may be configured to perform one or more processes described herein, such as process 400 of FIG. 4. In some aspects, the apparatus 500 or one or more components shown in FIG. 5 may include one or more components of the UE described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 502 may receive communications, such as reference signals, control information, data communications, or a combination thereof, from the apparatus 508. The reception component 502 may provide received communications to one or more other components of the apparatus 500. In some aspects, the reception component 502 may perform signal processing on the received communications, and may provide the processed signals to the one or more other components of the apparatus 500. In some aspects, the reception component 502 may include one or more components of the UE described above in connection with FIG. 1, such as a radio, one or more RF chains, one or more transceivers, or one or more modems, each of which may in turn be coupled with one or more antennas of the UE.

The transmission component 504 may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications, and may transmit the processed signals to the apparatus 508. In some aspects, the transmission component 504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 504 may be co-located with the reception component 502.

The communication manager 506 may support operations of the reception component 502 or the transmission component 504. For example, the communication manager 506 may receive information associated with configuring reception of communications by the reception component 502 or transmission of communications by the transmission component 504. Additionally, or alternatively, the communication manager 506 may generate or provide control information to the reception component 502 or the transmission component 504 to control reception or transmission of communications.

The communication manager 506 may identify a discard timer threshold for delay status report triggering. The communication manager 506 may trigger a delay status report for an RLC retransmission of a PDU based at least in part on a discard time associated with the PDU being below the discard timer threshold. The reception component 502 may receive, from a network node, an indication of the discard timer threshold. The reception component 502 may receive, from a network node, a grant for transmitting the delay status report.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

The following provides an overview of some Aspects of the present disclosure:

Aspect 1: A method of wireless communication performed by a user equipment (UE), comprising: identifying a discard timer threshold for delay status report triggering; and triggering a delay status report for a radio link control (RLC) retransmission of a protocol data unit (PDU) based at least in part on a discard time associated with the PDU being below the discard timer threshold.

Aspect 2: The method of Aspect 1, wherein the delay status report for the RLC retransmission of the PDU is triggered based at least in part on an indication of one or more protocol variables.

Aspect 3: The method of Aspect 2, wherein the indication of the one or more protocol variables comprises an indication associated with a poll timer.

Aspect 4: The method of any of Aspects 1-3, wherein the delay status report for the RLC retransmission of the PDU is triggered based at least in part on an indication of one or more protocols.

Aspect 5: The method of Aspect 4, wherein the indication of the one or more protocols comprises an indication associated with an autonomous retransmission of the PDU.

Aspect 6: The method of any of Aspects 1-5, wherein the delay status report for the RLC retransmission of the PDU is triggered based at least in part on the UE receiving a negative acknowledgment message from a peer RLC device via a status PDU indicator.

Aspect 7: The method of any of Aspects 1-6, wherein the delay status report for the RLC retransmission of the PDU is triggered based at least in part on one or more application-specific requirements.

Aspect 8: The method of any of Aspects 1-7, wherein the delay status report for the RLC retransmission of the PDU is triggered based at least in part on one or more inputs from one or more entities within a modem or an application processor of the UE.

Aspect 9: The method of any of Aspects 1-8, wherein the delay status report for the RLC retransmission of the PDU is triggered based at least in part on a type of interconnect between a modem and an application processor of the UE.

Aspect 10: The method of any of Aspects 1-9, further comprising receiving, from a network node, an indication of the discard timer threshold.

Aspect 11: The method of any of Aspects 1-10, wherein the discard timer threshold is identified based at least in part on a threshold, derived within a modem of the UE, based at least in part on a protocol state, application traffic, or an external input received from an application processor.

Aspect 12: The method of any of Aspects 1-11, wherein the delay status report for the RLC retransmission of the PDU is triggered based at least in part on a negative acknowledgement message received from a network node.

Aspect 13: The method of any of Aspects 1-12 further comprising receiving, from a network node, a grant for transmitting the delay status report.

Aspect 14: The method of any of Aspects 1-13, wherein triggering the delay status report comprises generating the delay status report and sending the delay status report as part of a delay status report medium access control (MAC) control element within a MAC transport block.

Aspect 15: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 16: An apparatus for wireless communication at a device, the apparatus comprising one or more memories and one or more processors coupled to the one or more memories, the one or more processors configured to cause the device to perform the method of one or more of Aspects 1-14.

Aspect 17: An apparatus for wireless communication, the apparatus comprising at least one means for performing the method of one or more of Aspects 1-14.

Aspect 18: A non-transitory computer-readable medium storing code for wireless communication, the code comprising instructions executable by one or more processors to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

Aspect 20: A device for wireless communication, the device comprising a processing system that includes one or more processors and one or more memories coupled with the one or more processors, the processing system configured to cause the device to perform the method of one or more of Aspects 1-14.

Aspect 21: An apparatus for wireless communication at a device, the apparatus comprising one or more memories and one or more processors coupled to the one or more memories, the one or more processors individually or collectively configured to cause the device to perform the method of one or more of Aspects 1-14.

Aspect 22: A device comprising a processing system that includes one or more processors and one or more code-storing memories coupled with the one or more processors, the processing system configured to cause the device to perform the method of one or more of Aspects 1-14.

Aspect 23: A device comprising a processing system that includes processor circuitry and code-storing memory circuitry, the processing system configured to cause the device to perform the method of one or more of Aspects 1-14.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled with the one or more memories and configured to cause the UE to:
identify a discard timer threshold for delay status report triggering; and
trigger a delay status report for a radio link control (RLC) retransmission of a protocol data unit (PDU) based at least in part on a discard time associated with the PDU being below the discard timer threshold.

2. The UE of claim 1, wherein the delay status report for the RLC retransmission of the PDU is triggered based at least in part on an indication of one or more protocol variables.

3. The UE of claim 2, wherein the indication of the one or more protocol variables comprises an indication associated with at least one of a poll timer, a time duration, a retransmission count, a bearer type, or a PDU session type.

4. The UE of claim 3, wherein the bearer type is at least one of a signaling bearer type, a user traffic bearer type, an application signaling bearer type, or a dedicated bearer type.

5. The UE of claim 3, wherein the PDU session type is at least one of a default PDU session type, a dedicated PDU session type, or a management PDU session type.

6. The UE of claim 1, wherein the delay status report for the RLC retransmission of the PDU is triggered based at least in part on an indication of one or more protocols.

7. The UE of claim 6, wherein the indication of the one or more protocols comprises an indication associated with an autonomous retransmission of the PDU.

8. The UE of claim 1, wherein the delay status report for the RLC retransmission of the PDU is triggered based at least in part on the UE receiving a negative acknowledgment message from a peer RLC device via a status PDU indicator or based at least in part on an implicit negative acknowledgement that is derived based at least in part on a hybrid automatic repeat request (HARQ) feedback indication or a medium access control signal.

9. The UE of claim 1, wherein the delay status report for the RLC retransmission of the PDU is triggered based at least in part on one or more application-specific requirements.

10. The UE of claim 9, wherein the one or more application-specific requirements comprise an application-specific protocol, an application-specific packet type, or an application-specific importance bit.

11. The UE of claim 1, wherein the delay status report for the RLC retransmission of the PDU is triggered based at least in part on one or more inputs from one or more entities within a modem or an application processor of the UE.

12. The UE of claim 1, wherein the delay status report for the RLC retransmission of the PDU is triggered based at least in part on a type of interconnect between a modem and an application processor of the UE.

13. The UE of claim 1, wherein the one or more processors are further configured to cause the UE to receive, from a network node, an indication of the discard timer threshold.

14. The UE of claim 1, wherein the discard timer threshold is identified based at least in part on a threshold, derived within a modem of the UE, based at least in part on a protocol state, application traffic, or an external input received from an application processor.

15. The UE of claim 1, wherein the delay status report for the RLC retransmission of the PDU is triggered based at least in part on a negative acknowledgement message received from a network node.

16. The UE of claim 1, wherein the one or more processors are further configured to cause the UE to receive, from a network node, a grant for transmitting the delay status report.

17. The UE of claim 1, wherein the one or more processors, to cause the UE to trigger the delay status report, are configured to cause the UE to generate the delay status report and sending the delay status report as part of a delay status report medium access control (MAC) control element within a MAC transport block.

18. A method of wireless communication performed by a user equipment (UE), comprising:
identifying a discard timer threshold for delay status report triggering; and
triggering a delay status report for a radio link control (RLC) retransmission of a protocol data unit (PDU) based at least in part on a discard time associated with the PDU being below the discard timer threshold.

19. The method of claim 18, wherein the delay status report for the RLC retransmission of the PDU is triggered based at least in part on an indication of one or more protocol variables.

20. A non-transitory computer-readable medium storing a set of instructions for wireless communication, the set of instructions comprising:
one or more instructions that, when executed by one or more processors of a user equipment (UE), cause the UE to:
identify a discard timer threshold for delay status report triggering; and
trigger a delay status report for a radio link control (RLC) retransmission of a protocol data unit (PDU) based at least in part on a discard time associated with the PDU being below the discard timer threshold.
